(19) United States
(12) Patent Application Publication
(10) Pub. No.: US 2012/0186092 A1
(43) Pub. Date: Jul. 26, 2012

(54) Electrical Outlet Bubble Level

(75) Inventor: David Nikayin, Los Angeles, CA (US)

(73) Assignee: Orbit Industries, Inc.

(21) Appl. No.: 13/012,665

(22) Filed: Jan. 24, 2011

(51) Int. Cl. G01C 9/24

(52) U.S. Cl. 33/379

(57) ABSTRACT

An orientation indicator such as an electrical outlet bubble level may be safely and removably secured to an electrical outlet with non-conductive pins. The orientation indicator includes a bubble level vial which will identify when the outlet is level, or perpendicular to level, as displayed by the bubble level vial.

### FIELD OF THE INVENTIONS

The inventions described below relate to the field of electrical construction components and more specifically to bubble level for orienting electrical outlets.

### BACKGROUND OF THE INVENTIONS

Conventionally, orientation of electrical outlets is done by eye just prior to attachment of the cover plate. The straight edges of the cover plate highlight any misalignment from level, in the outlet. Use of a conventional bubble level to orient the outlets requires one hand to hold the level against the outlet and the other to change the orientation and secure the attachment screws. This is very clumsy and not consistent with efficient finishing of a construction project.

### SUMMARY

The devices and methods described below provide for an orientation indicator that may be safely and removably secured to an electrical outlet with non-conductive pins. The orientation indicator includes a bubble level vial which will identify when the outlet is level, or perpendicular to level, as displayed by the bubble level vial. The bubble level vial is secured within a generally open frame with one or more sets of securing pins extending from the frame. A set of securing pins removably engage the grounding pin holes in the electrical outlet to hold the bubble level vial in a fixed orientation relative to the electrical outlet.

### BRIEF DESCRIPTION OF THE DRAWINGS

FIG. 1 is a perspective view of an electrical outlet bubble level.

FIG. 2 is a front view of the electrical outlet bubble level of FIG. 1.

FIG. 3 is a side view of the electrical outlet bubble level of FIG. 1.

FIG. 4 is a perspective view of the electrical outlet bubble level of FIG. 1 oriented to engage an electrical outlet.

### DETAILED DESCRIPTION OF THE INVENTIONS

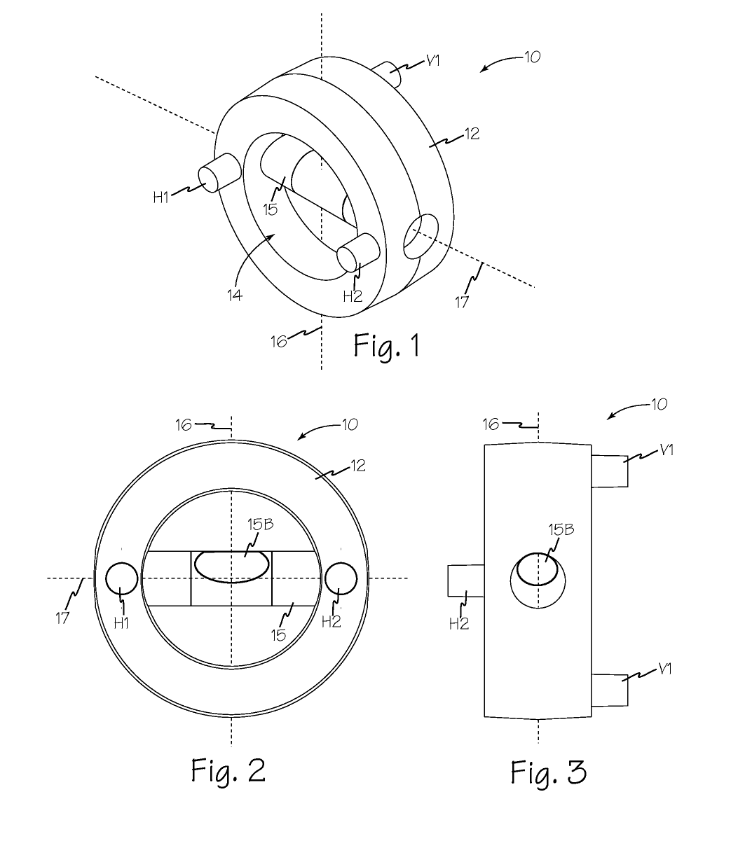

Electrical outlet bubble level 10 of FIGS. 1, 2 and 3 includes frame 12 which is generally open and forms at least one viewing port such as viewing port 14. Frame 12 includes at least one non-conductive attachment pin such as vertical pins V1 and V2 as well as horizontal pins H1 and H2. Frame 12 also secures generally cylindrical bubble level vial 15 in a fixed orientation relative to the attachment pin or pins.

Frame 12 is illustrated as annular, although any other suitable shape may be adopted such as toroidal, square, triangular, or other complex shape.

Bubble level vial 15 is generally oriented relative to the attachment pins to provide a level indication and a perpendicular-to-level indication. Bubble 15B within bubble level vial 15 indicates when the vial is oriented level, that is horizontal with respect to the local gravitational field. As an orientation indicator, bubble level 10 has a first or vertical axis such as vertical axis 16 which is perpendicular to the orientation of bubble level vial 15, and a second or horizontal axis such as horizontal axis 17 which is parallel to the orientation of bubble level vial 15. To engage an electrical component such as an electrical outlet, one or more attachment pins such as vertical pins V1 and V2 are oriented to extend from frame 12 aligned with, or parallel to vertical axis 16. On bubble level 10, a second set of attachment pins, horizontal pins H1 and H2 are oriented to extend from frame 12 aligned with, or parallel to horizontal axis 17. Other suitable orientations may be used.

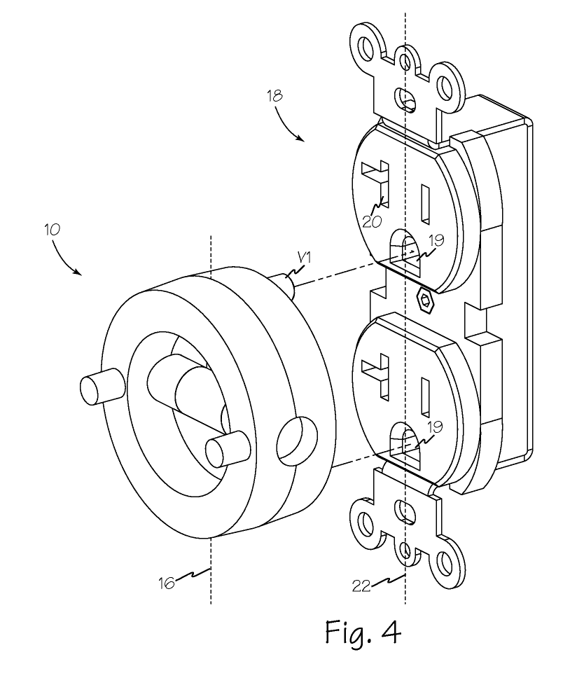

In use, an orientation indicator such as outlet level 10 of FIG. 4 engages an electrical outlet such as outlet 18 to provide orientation information regarding outlet 18. Attachment pins are sized and dimensioned to engage one or more openings in an electrical component such as ground pin sockets 19, or conductor sockets such as conductor socket 20. By engaging each vertical attachment pin to a ground pin socket, vertical axis 16 of outlet level 10 is aligned with longitudinal axis 22 of outlet 18. When the bubble in the bubble level vial is centered in the vial, then longitudinal or long axis 22 of outlet 18 is aligned perpendicular to level.

Alternatively, by engaging the horizontal attachment pins such as pins H1 and H2 to an outlet, the long axis of the outlet may be aligned with level or horizontal.

While the preferred embodiments of the devices and methods have been described in reference to the environment in which they were developed, they are merely illustrative of the principles of the inventions. The elements of the various embodiments may be incorporated into each of the other species to obtain the benefits of those elements in combination with such other species, and the various beneficial features may be employed in embodiments alone or in combination with each other. Other embodiments and configurations may be devised without departing from the spirit of the inventions and the scope of the appended claims.

I claim:

1. An orientation indicator for electrical components comprising:
an annular frame;
a bubble level vial secured in a fixed orientation within the frame;
at least one set of attachment pins extending from the frame, the attachment pins sized and dimensioned to removably secure the orientation indicator to the electrical component.
